(19) United States
(12) Patent Application Publication
(10) Pub. No.: US 2016/0130145 A1
(43) Pub. Date: May 12, 2016

(54) METHOD FOR MAKING CATHODE MATERIAL OF LITHIUM ION BATTERY

(71) Applicants: Jiangsu Huadong Institute of Li-ion Battery Co. Ltd., Zhangjiagang (CN); Tsinghua University, Beijing (CN)

(72) Inventors: ZHONG-JIA DAI, Beijing (CN); LI WANG, Beijing (CN); XIANG-MING HE, Beijing (CN); JIAN-JUN LI, Beijing (CN)

(21) Appl. No.: 14/996,242

(22) Filed: Jan. 15, 2016

Related U.S. Application Data
(63) Continuation of application No. PCT/CN2014/081685, filed on Jul. 4, 2014.

(30) Foreign Application Priority Data
Jul. 15, 2013 (CN) 201310294345.8

(51) Int. Cl. C01B 25/45; H01M 4/58; H01M 10/0525

(52) U.S. Cl. CPC C01B 25/45; H01M 10/0525; H01M 4/5825; H01M 2004/028

(57) ABSTRACT

A method for making a cathode material of a lithium ion battery is disclosed. A manganese source liquid solution, a lithium source liquid solution, a phosphate source liquid solution, and a metal M source liquid solution are provided. The manganese source and the metal M source are salts of strong acids. The Mn source liquid solution, the metal M source liquid solution, the Li source liquid solution, and the phosphate source liquid solution are mixed to form a mixing solution having a total concentration among the manganese source, metal M source, lithium source, and phosphate source less than or equal to 3 mol/L. The mixing solution is solvothermal synthesized to form a product represented by LiMn₍₁₋ₓ₎MₓPO₄, wherein 0<x≦0.1.

### CROSS-REFERENCE TO RELATED APPLICATIONS

This application claims all benefits accruing under 35 U.S.C. §119 from China Patent Application No. 201310294345.8, filed on Jul. 15, 2013 in the China Intellectual Property Office, the content of which is hereby incorporated by reference. This application is a continuation under 35 U.S.C. §120 of international patent application PCT/CN2014/081685 filed Jul. 4, 2014.

### FIELD

The present disclosure relates to methods for making cathode materials of lithium ion batteries.

### BACKGROUND

Lithium iron phosphate (LiFePO₄) is an attractive cathode active material and has advantages of high safety, low cost, and environmental friendliness. However, the discharge voltage plateau of the lithium iron phosphate is 3.4V, which restricts an energy density of the lithium ion battery. Compared with the lithium iron phosphate, lithium manganese phosphate (LiMnPO₄) greatly increases the energy density of the lithium ion battery. However, the lithium manganese phosphate has a relatively low electronic conductivity and lithium ion diffusion rate which are undesirable in actual use.

To improve the electronic conductivity and lithium ion diffusion rate of the lithium manganese phosphate, metal elements are commonly doped in the lithium manganese phosphate by using a solid-phase synthesizing method. In the method, a phosphorus source, a lithium source, a manganese source, a metal element source, and a solvent are proportionally mixed, ball-milled, and then calcined at a high temperature in an inert gas environment to form the doped lithium manganese phosphate. The solid-phase synthesizing method is simple, however has deficiencies. For example, the achieved doped lithium manganese phosphate has a relatively large and non-uniform particle size, which makes the doped lithium manganese phosphate has a low stability in cycling performance.

### BRIEF DESCRIPTION OF THE DRAWINGS

Implementations are described by way of example only with reference to the attached figures.

FIG. 1 is a flow chart of an embodiment of a method for making a cathode material of a lithium ion battery.

FIG. 2 shows X-ray diffraction (XRD) patterns of LiMn_{0.9}Fe_{0.1}PO₄ samples formed in Examples 1, 2, and 3 and Comparative Example.

FIG. 3 shows a comparison between XRD pattern of LiMn_{0.9}Fe_{0.1}PO₄ samples formed in Example 1 and Comparative Example, and XRD pattern of LiMnPO₄.

FIG. 4 shows a scanning electron microscope (SEM) image of LiMn_{0.9}Fe_{0.1}PO₄ sample formed in Example 1.

FIG. 5 shows a SEM image of LiMn_{0.9}Fe_{0.1}PO₄ sample formed in Example 2.

FIG. 6 shows a SEM image of LiMn_{0.9}Fe_{0.1}PO₄ sample formed in Example 3.

FIG. 7 shows a SEM image of LiMn_{0.9}Fe_{0.1}PO₄ sample formed in Comparative Example.

FIG. 8 shows cycling performances of lithium ion batteries using the samples of Examples 4 and 5 and 0.1 C current rate.

FIG. 9 shows charge and discharge curves at 1^{st}, 15^{th}, and 30^{th} cycle of lithium ion battery using the sample of Example 4 and 0.1 C current rate.

FIG. 10 shows cycling performances of lithium ion batteries using the samples of Examples 4 and 5 and different current rates.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “comprise” or “comprising” when utilized, means “include or including, but not necessarily limited to”; it specifically indicates open-ended inclusion or membership in the so-described combination, group, series, and the like.

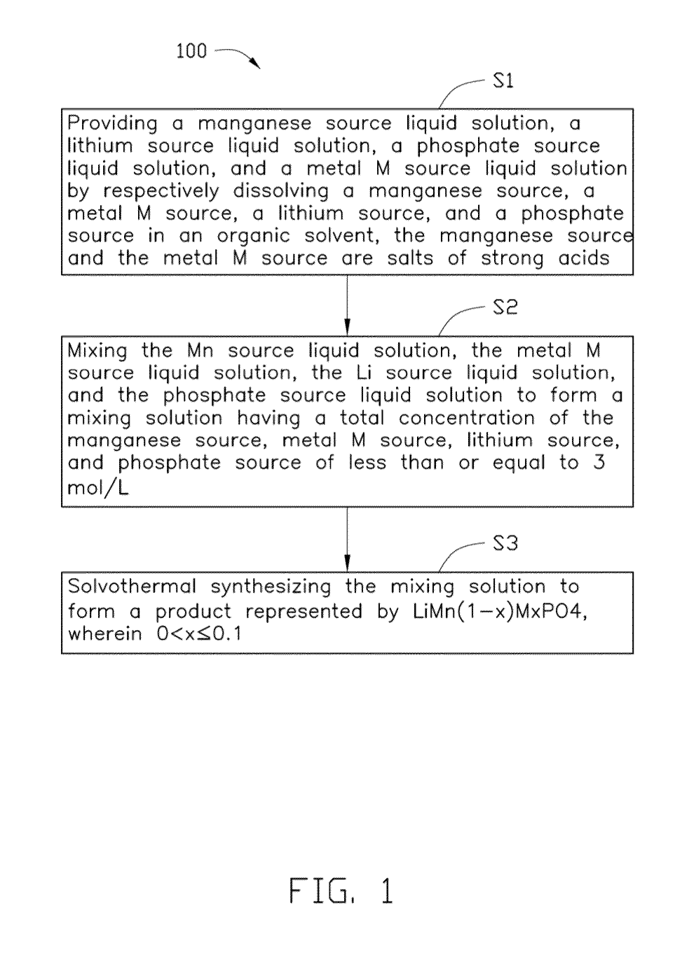

FIG. 1 presents a flowchart in accordance with an illustrated example embodiment. The embodiment of a method 100 for making a cathode material of a lithium ion battery is provided by way of example, as there are a variety of ways to carry out the method 100. Each block shown in FIG. 1 represents one or more processes, methods, or subroutines carried out in the exemplary method 100.

At block S1, a manganese (Mn) source liquid solution, a lithium (Li) source liquid solution, a phosphate (PO₄) source liquid solution, and a metal M source liquid solution are respectively provided. The Mn source liquid solution, metal M source liquid solution, Li source liquid solution, and phosphate source liquid solution are respectively formed by dissolving a manganese source, a metal M source, a lithium source, and a phosphate source in an organic solvent. The manganese source and the metal M source are salts of strong acids.

At block S2, the Mn source liquid solution, metal M source liquid solution, Li source liquid solution, and phosphate source liquid solution are mixed to form a mixing solution. In the mixing solution, a total concentration of the manganese source, metal M source, lithium source, and phosphate source is less than or equal to 3 mol/L.

At block S3, the mixing solution is solvothermal synthesized to form a product represented by LiMn₍₁₋ₓ₎MₓPO₄, wherein 0<x≦0.1.

At block S1, the manganese source, the metal M source, the lithium source, and the phosphate source are capable of being dissolved in the organic solvent respectively to form manganese ions, metal M ions, lithium ions, and phosphate ions. The metal element M in the metal M source can be selected from one or more chemical elements of alkaline-earth metal elements, Group-13 elements, Group-14 elements, and transition metal elements, and can be one or more elements selected from Fe, Co, Ni, Mg, and Zn in one embodiment. The manganese source and the metal M source are salts of strong acids that completely ionize (dissociate) in a solution. The salts of strong acids can be such as nitrate, sulfate, and chloride salts. The manganese source can be one or more of manganese sulfate, manganese nitrate, and manganese chloride. The metal M source can be one or more of metal element M contained sulfate, nitrate, and chloride. The lithium source can be one or more of lithium hydroxide, lithium chloride, lithium sulfate, lithium nitrate, lithium dihydrogen orthophosphate, and lithium acetate. The phosphate source can be one or more of phosphoric acid (H₃PO₄), LiH₂PO₄, triammonium phosphate (NH₃PO₄), monoammonium phosphate (NH₄H₂PO₄), and dioammonium phosphate ((NH₄)₂HPO₄).

The organic solvent is capable of dissolving the manganese source, metal M source, lithium source, and phosphate source, and can be diols and/or polyols, such as ethylene glycol, glycerol, diethylene glycol, triethylene glycol, tetraethylene glycol, 1,2,4-butanetriol, and combinations thereof. By simply using the organic solvent in the liquid solutions, a hydrolysis reaction of the reactants can be prevented, and accordingly the morphology of the product can be easily controlled. The material of the organic solvent can be selected according to the material of the manganese source, the metal M source, the lithium source, and the phosphate source. The manganese source liquid solution, the metal M source liquid solution, the lithium source liquid solution, and the phosphate source liquid solution can have different organic solvents. However, at block S2, the liquid solutions are mixed with each other. Therefore, the organic solvent in any liquid solution should be able to dissolve all of the manganese source, the metal M source, the lithium source, and the phosphate source.

In one embodiment, the solvent of the manganese source liquid solution, the metal M source liquid solution, the lithium source liquid solution, and the phosphate source liquid solution only comprises the organic solvent. In another embodiment, the solvent of the manganese source liquid solution, the metal M source liquid solution, the lithium source liquid solution, and the phosphate source liquid solution not only comprises the organic solvent but also comprises a small quantity of water accompanying with the organic solvent. In some embodiments, the manganese source, the metal M source, the lithium source, and the phosphate source may have water of crystallization. When dissolving the manganese source, the metal M source, the lithium source, and the phosphate source into the organic solvent, the water of crystallization can be dissolved in the organic solvent to introduce water in the liquid solutions. However, a volume ratio between the water and the organic solvent should be smaller than or equal to 1:10. In one embodiment, the volume ratio is smaller than 1:50.

At block S2, the lithium source liquid solution, the manganese source liquid solution, the metal M source liquid solution, and the phosphate source liquid solution are mixed in a molar ratio of Li:(M+Mn):P=(2˜3):1:(0.8˜1.5). The mixing solution contains 1 part element M and Mn, 2˜3 parts element Li, and 0.8˜1.5 parts element P. In one embodiment, the molar ratio of Li:(M+Mn):P=1:1:1.

In one embodiment, the phosphate source, the manganese source, and the metal M source liquid solution can be previously mixed to form a first solution, and then the lithium source liquid solution can be mixed with the first solution, to form a second solution. In another embodiment, the lithium source liquid solution and the phosphate source liquid solution can be previously mixed to form a third solution, and then the manganese source and the metal M source liquid solution can be mixed with the third solution to form a fourth solution. The manganese source, metal M source, lithium source, and phosphate source are dissolved and mixed in liquid phase to mix with each other at an atomic level, which avoids the segregation, aggregation, and non-uniform among batches occurred in the solid phase synthesizing method.

Further, to have a uniform mixture, the mixing solution can be stirred mechanically or ultrasonically.

To avoid the phase separation in the product that forms LiMPO₄ and LiMnPO₄, a total concentration of the manganese source, the metal M source, the lithium source, and the phosphate source is less than or equal to 3 mol/L in the mixing solution. When the manganese source and the metal M source are salts of weak acids, the phase separation that forms Li₃PO₄ in the product may also occur. Therefore, to obtain the pure LiMn₍₁₋ₓ₎MₓPO₄, the manganese source and the metal M source are salts of strong acids, and the total concentration of the manganese source, the metal M source, the lithium source, and the phosphate source is less than or equal to 3 mol/L in the mixing solution.

At block S3, the mixing solution can have a solvothermal reaction in a solvothermal reactor, such as a sealed autoclave. The solvothermal reactor can be heated, and a vapor of the solvent in the solvothermal reactor can be generated to increase the pressure inside the solvothermal reactor. The mixing solution performs a solvothermal reaction at the elevated temperature and the elevated pressure to form the LiMn₍₁₋ₓ₎MₓPO₄ nanograins. The pressure inside the solvothermal reactor can be in a range from about 5 MPa to about 30 MPa. The temperature inside the solvothermal reactor can be in a range from about 150° C. to about 250° C. The reacting time can be in a range from about 1 hour to about 24 hours. After the solvothermal reaction, the solvothermal reactor can be naturally cooled to room temperature.

After the block S3, the product can be taken from the solvothermal reactor, then washed and dried. The product can be washed, filtered, and centrifugalized by deionized water several times. Then the product can be dried by suction filtration or heating.

Furthermore, after the block S3, the product can be further coated with carbon. In the carbon coating, the formed LiMn₍₁₋ₓ₎MₓPO₄ is mixed with a carbon source liquid solution to form a mixture. The carbon source liquid solution is formed by dissolving or dispersing a carbon source compound in a solvent. The carbon source compound can be a reductive organic chemical compound which can be pyrolyzed at a sintering temperature to form only elemental carbon, such as amorphous carbon, in solid phase. The carbon source compound can be selected from sucrose, glucose, Span 80, phenolic resins, epoxy resins, furan resins, polyacrylic acid, polyacrylonitrile, polyethylene glycol, and polyvinyl alcohol. A concentration of the carbon source compound in the carbon source liquid solution can be in a range from 0.005 g/ml to 0.05 g/ml. The mixture can be stirred to uniformly mix the LiMn₍₁₋ₓ₎MₓPO₄ nanograins with the carbon source liquid solution. In one embodiment, the mixture can be vacuumed to evacuate gas between the LiMn₍₁₋ₓ₎MₓPO₄ nanograins. After filtered and dried, the mixture can be sintered in a protective gas or in vacuum at a sintering temperature. The sintering temperature can be in a range from about 300° C. to about 800° C. The sintering time can be in a range from about 0.3 hours to about 8 hours.

By controlling the solvothermal reaction conditions, pure LiMn₍₁₋ₓ₎MₓPO₄ nanograins having a high crystallinity degree and an uniform size distribution can be obtained. The LiMn₍₁₋ₓ₎MₓPO₄ nanograins have a size smaller than 100 nanometers. The LiMn₍₁₋ₓ₎MₓPO₄ nanograins have relatively good dispersing ability. A morphology of the LiMn₍₁₋ₓ₎MₓPO₄ nanograins can be narrow bar shaped or wide sheet shaped, which is related to the materials of the manganese source, the metal M source, the lithium source, and the phosphate source. By having the same conditions in the method, a same morphology among the LiMn₍₁₋ₓ₎MₓPO₄ nanograins can be obtained.

### Example 1

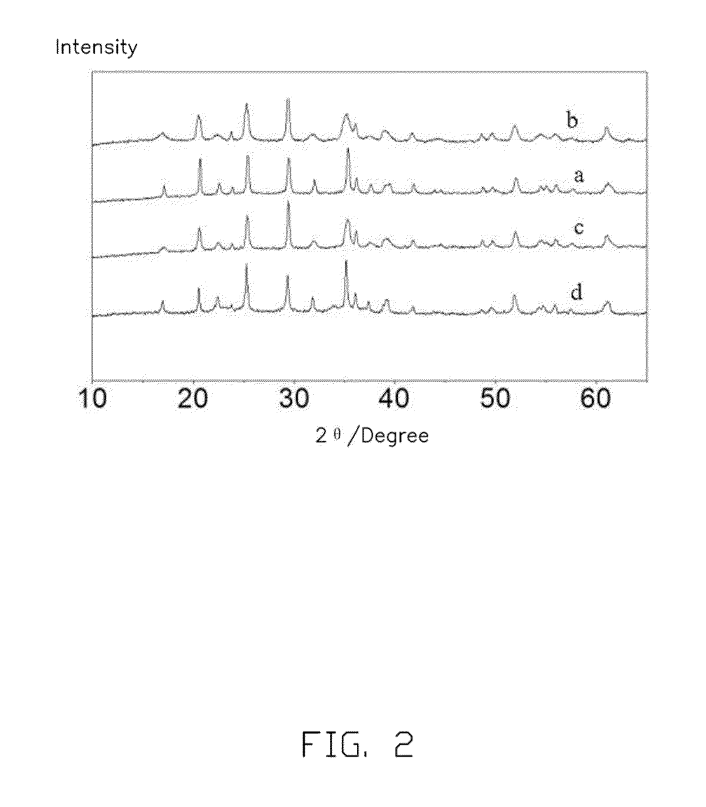

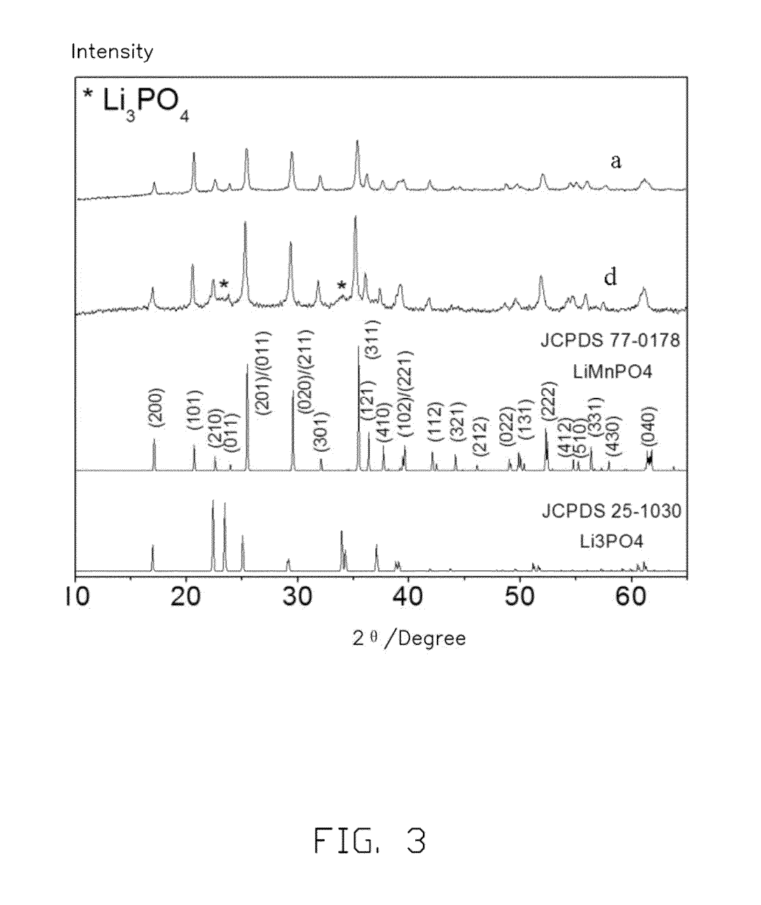

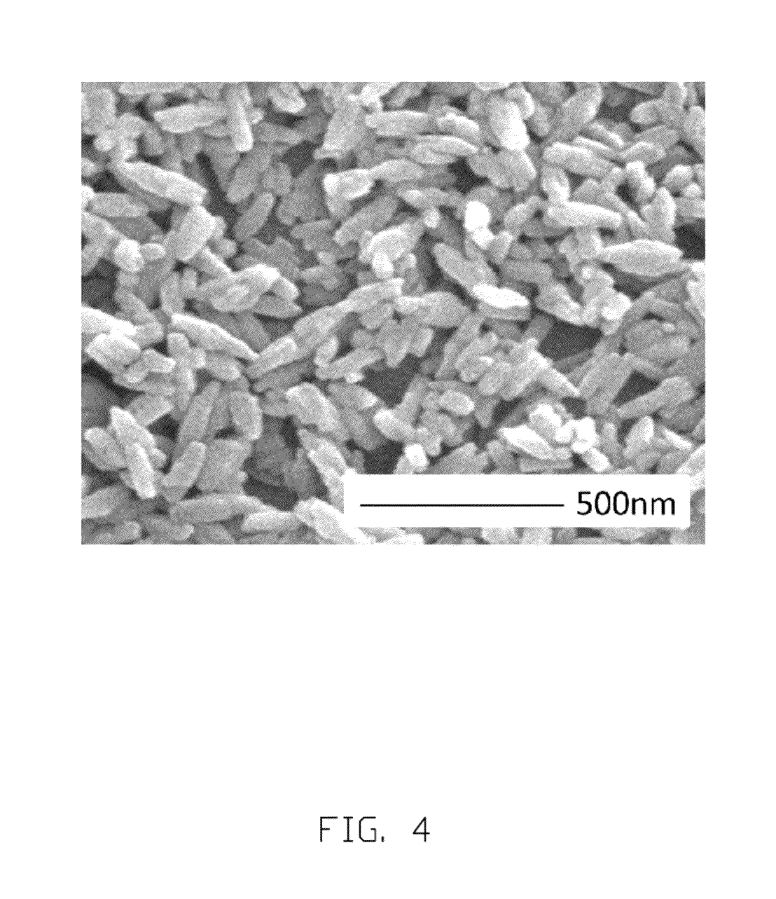

The lithium source is LiOH.H₂O. The metal M source is FeSO₄.7H₂O. The manganese source is MnCl₂.4H₂O. The phosphate source is H₃PO₄. The organic solvent is ethylene glycol. The FeSO₄.7H₂O, MnCl₂.4H₂O, LiOH.H₂O and H₃PO₄ are dissolved in the organic solvent to respectively form liquid solutions. By mixing and stirring the FeSO₄, MnCl₂, and H₃PO₄ liquid solutions, the first solution is obtined. The LiOH solution is gradually dropped to the first solution and stirred for 30 minutes to form the second solution having a concentration of the Mn²⁺ of about 0.18 mol/L, a concentration of Fe²⁺ of about 0.02 mol/L, a concentration of Li⁺ of about 0.54 mol/L, and a concentration of PO₄³⁻ of about 0.2 mol/L. In the second solution, a molar ratio among Li⁺ Fe²⁺ Mn²⁺, and PO₄³⁻ is about 2.7:1:1. The second solution is sealed in the solvothermal reactor and heated at 180° C. for about 12 hours. The product is taken out from the reactor after it is naturally cooled down to room temperature. An XRD test is applied after the product is washed with deionized water 5 times and dried at 80° C. Referring to FIG. 2 and FIG. 3, the curve b is the XRD pattern of the product in Example 1, which matches the standard lithium manganese phosphate XRD pattern indicating that the product is pure LiMn_{0.9}Fe_{0.1}PO₄. Referring to FIG. 4, it can be seen from the SEM photo that the product has a uniform bar shaped morphology having a length smaller than 100 nanometers, a width smaller than 30 nanometers, and a thickness smaller than 30 nanometers.

### Example 2

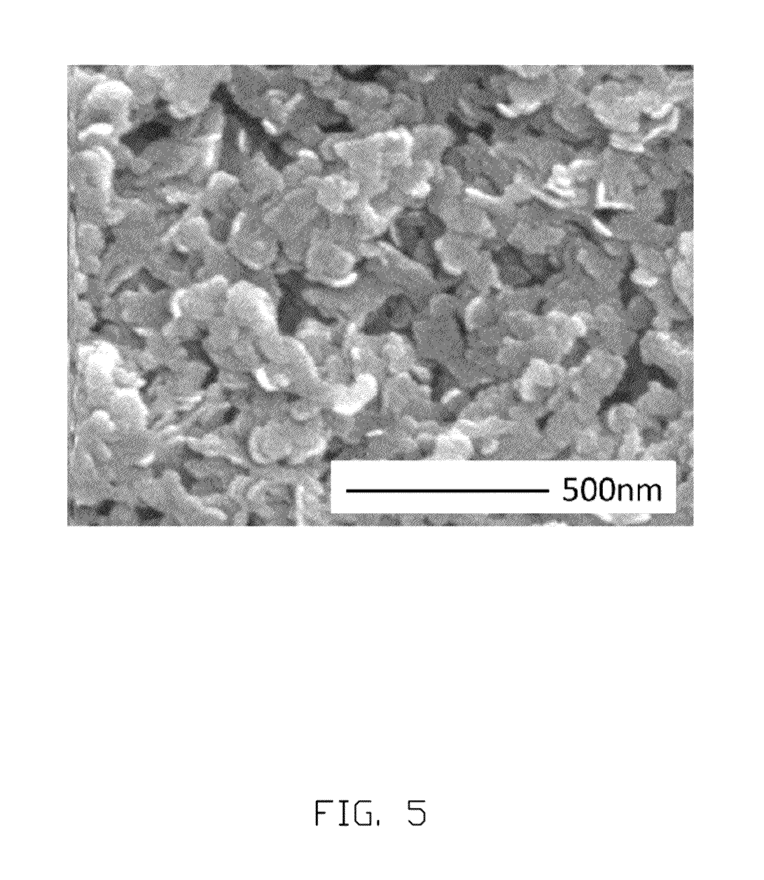

The lithium source is LiOH.H₂O. The metal M source is FeCl₂.4H₂O. The manganese source is MnCl₂.4H₂O. The phosphate source is H₃PO₄. The organic solvent is ethylene glycol. The LiOH.H₂O, H₃PO₄, FeCl₂.4H₂O and MnCl₂.4H₂O are dissolved in the organic solvent to respectively form liquid solutions. By mixing and stirring the LiOH and H₃PO₄ liquid solutions, the third solution is obtined. The FeCl₂ and LiOH solutions are added to the third solution and stirred for 30 minutes to form the fourth solution having a concentration of the Mn²⁺ of about 0.18 mol/L, a concentration of Fe²⁺ of about 0.02 mol/L, a concentration of Li⁺ of about 0.54 mol/L, and a concentration of PO₄³⁻ of about 0.2 mol/L. In the fourth solution, a molar ratio among Li⁺, Fe²⁺+Mn²⁺, and PO₄³⁻ is about 2.7:1:1. The second solution is sealed in the solvothermal reactor and heated at 180° C. for about 12 hours. The product is taken out from the reactor after it is naturally cooled down to room temperature. An XRD test is applied after the product is washed with deionized water 5 times and dried at 80° C. Referring to FIG. 2, the curve a is the XRD pattern of the product in Example 2, which matches the standard lithium manganese phosphate XRD pattern indicating that the product is pure LiMn_{0.9}Fe_{0.1}PO₄. Referring to FIG. 5, it can be seen from the SEM photo that the product has a uniform sheet shaped morphology having a thickness smaller than 30 nanometers.

### Example 3

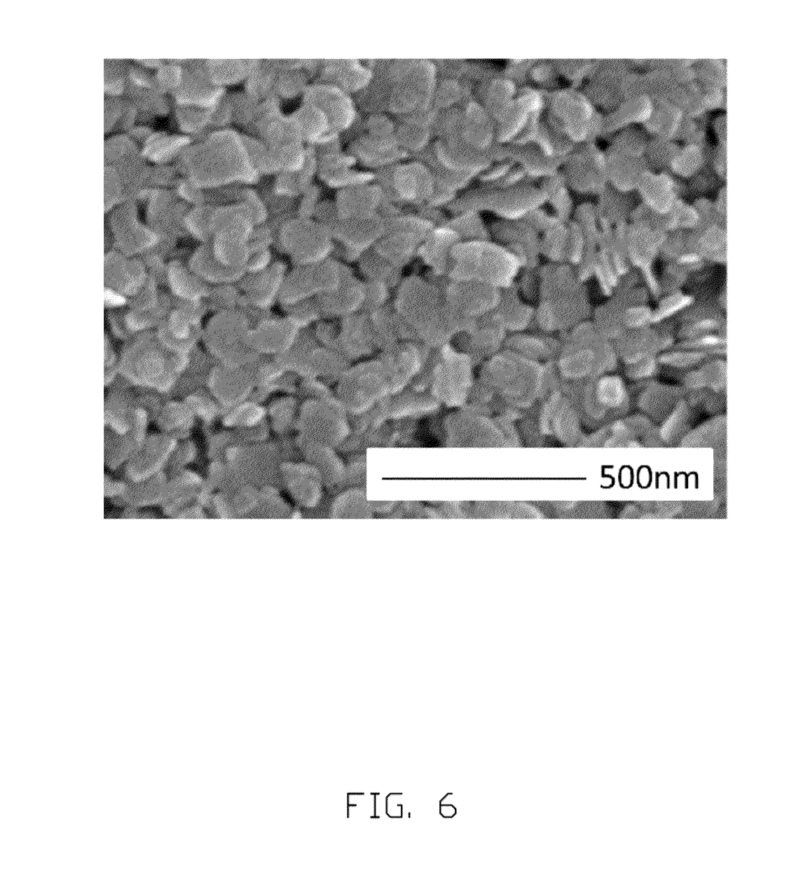

Example 3 is the same as Example 2, except that the metal M source is FeSO₄.7H₂O. Referring to FIG. 2, the curve c is the XRD pattern of the product in Example 3, which matches the standard lithium manganese phosphate XRD pattern indicating that the product is pure LiMn_{0.9}Fe_{0.1}PO₄. Referring to FIG. 6, it can be seen from the SEM photo that the product has a uniform sheet shaped morphology and a uniform size distribution.

### COMPARATIVE EXAMPLE

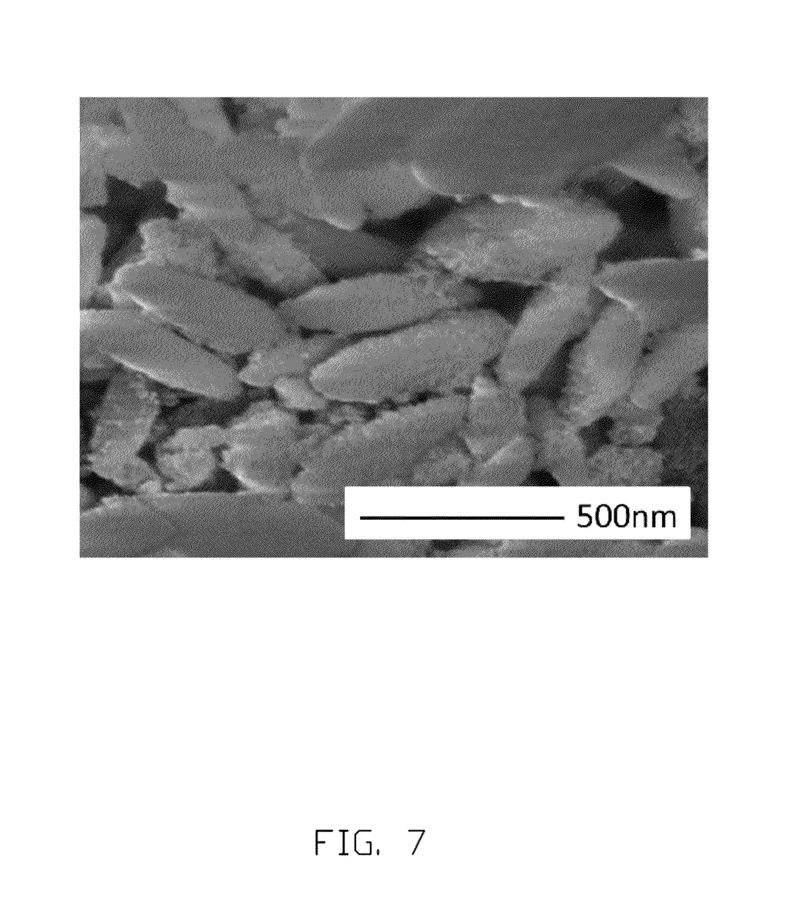

Comparative Example is the same as Example 1, except that the manganese source is Mn(CH₃COO)₂ and the metal M source is FeCl₂.4H₂O. Referring to FIGS. 2 and 3, the curve d is the XRD pattern of the product in Comparative Example having peaks that indicates the product comprises Li₃PO₄. Therefore, by using the Mn(CH₃COO)₂ as the manganese source, the pure LiMn_{0.9}Fe_{0.1}PO₄ cannot formed. Referring to FIG. 7, it can be seen from the SEM photo that the product has an apparent larger size compared with the products in Examples 1, 2, and 3.

### Example 4

The LiMn_{0.9}Fe_{0.1}PO₄ in Example 1 is mixed with a sucrose solution having a weight percentage of about 12% and stirred for 30 minutes to obtain a mixture. The mixture is sintered in nitrogen gas enviornment at 650° C. for 5 hours to form the LiMn_{0.9}Fe_{0.1}PO₄—carbon composite. A CR2032 coin type lithium ion battery is assembled. The cathode is formed by having 80% by weight of LiMn_{0.9}Fe_{0.1}PO₄—carbon composite, 5% by weight of acetylene black, 5% by weight of conductive graphite, and 10% by weight of polyvinylidene fluoride. The anode is lithium metal. The separator is Celgard 2400 polypropylene microporous film. The electrolyte is 1 mol/L LiPF₆/EC+DMC+EMC (1:1:1, v/v/v). The lithium ion battery is rested at room temperature for a period of time and then tested.

### Example 5

The LiMn_{0.9}Fe_{0.1}PO₄ in Example 3 is mixed with a sucrose solution having a weight percentage of about 12% and stirred for 30 minutes to obtain a mixture. The mixture is sintered in nitrogen gas enviornment at 650° C. for 5 hours to form the LiMn_{0.9}Fe_{0.1}PO₄—carbon composite. A CR2032 coin type lithium ion battery is assembled. The cathode is formed by having 80% by weight of LiMn_{0.9}Fe_{0.1}PO₄—carbon composite, 5% by weight of acetylene black, 5% by weight of conductive graphite, and 10% by weight of polyvinylidene fluoride. The anode is lithium metal. The separator is Celgard 2400 polypropylene microporous film. The electrolyte is 1 mol/L LiPF₆/EC+DMC+EMC (1:1:1, v/v/v). The lithium ion battery is rested at room temperature for a period of time and then tested.

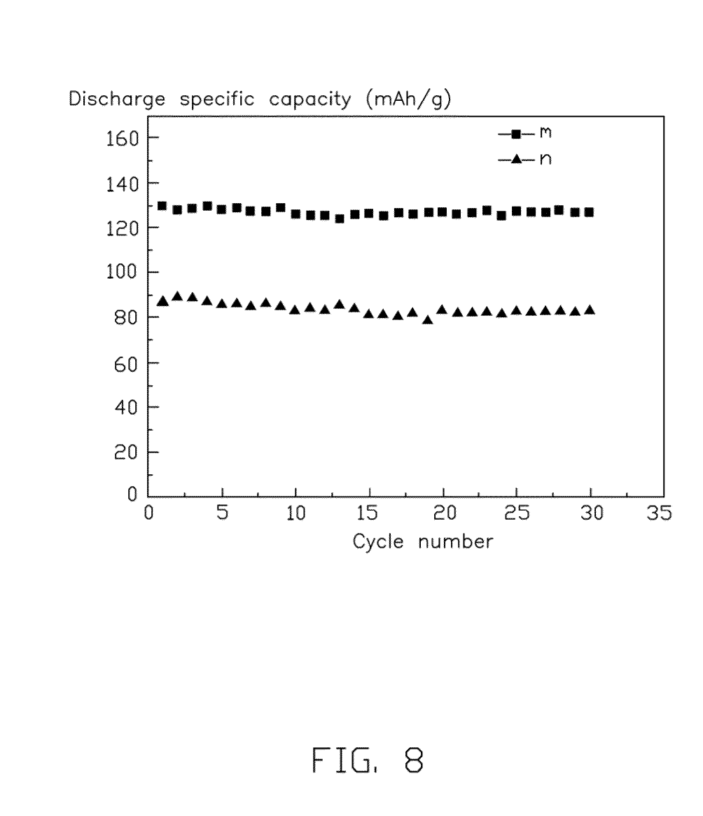

Referring to FIG. 8 to FIG. 10, the test results of the lithium ion batteries in Examples 4 and 5 are compared. As shown in FIG. 8, the curve m is the cycling performance of the lithium ion battery in Example 4, and the curve n is the cycling performance of the lithium ion battery in Example 5. The two lithium ion batteries are both cycled using 0.1 C current rates. Example 4's battery has a first discharge specific capacity of about 129.7 mAh/g and a capacity retention of about 98% after 30 cycles. Example 5's battery has a first discharge specific capacity of about 87 mAh/g and a capacity retention of about 96% after 30 cycles. Both the batteries of Examples 4 and 5 have relatively high capacity retentions. However, the LiMn_{0.9}Fe_{0.1}PO₄ nanograins in Example 1 have a smaller width than that in Example 3, which may be the reasion that Example 4's battery has a higher specific capacity, because the decrease of the thickness shortens the diffusion distance and increases the diffusion rate of the lithium ions.

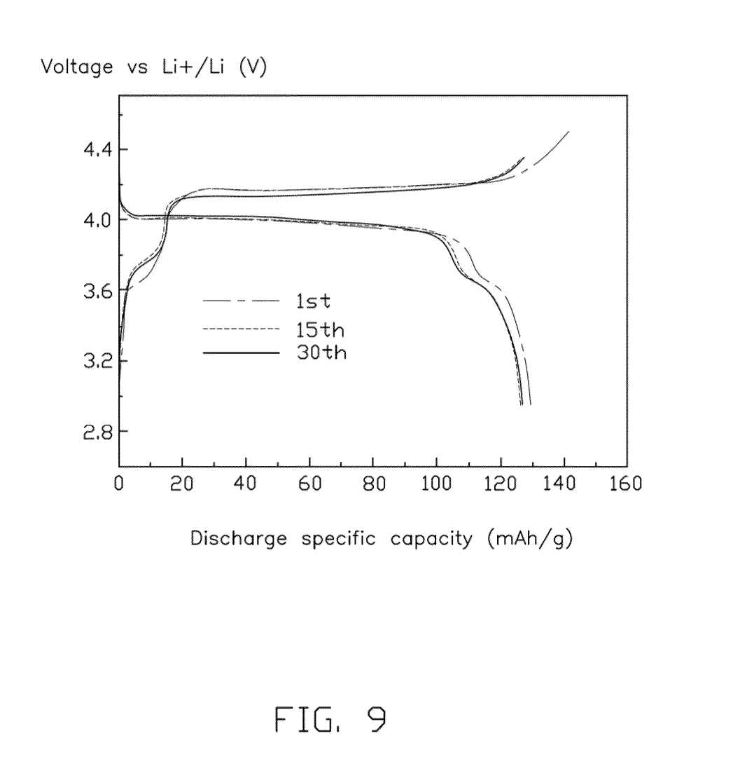

Referring to FIG. 9, which shows the charge and discharge curves at 1^{st}, 15^{th}, and 30^{th} cycles by using 0.1 C current rate of the battery in Example 4. There are two discharge plateaus at 3.5V and 4.1V respectively in the discharge curves. The width ratio between the two discharge plateaus, which is 1:9, is equal to the molar ratio of the Fe²⁺ and the Mn²⁺ in the cathode, which further proves that the pure LiMn_{0.9}Fe_{0.1}PO₄ is obtained in the method.

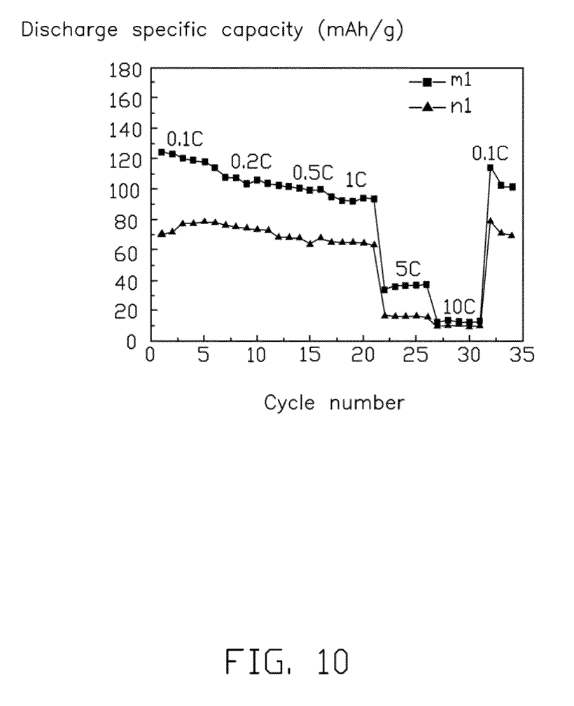

Referring to FIG. 10, the curve ml is the cycling performances at different discharge current rates of the lithium ion battery in Example 4, and the curve n1 is the cycling performances at different discharge current rates of the lithium ion battery in Example 5. At 1 C current rate, the discharge specific capacities of the batteries in Examples 4 and 5 are about 95.2 mAh/g and 65 mAh/g respectively. At 5 C current rate, both of the discharge specific capacities of the Examples 4 and 5′ batteries greatly drop, which is contributed by the polarization of the electrode at the high current rate. As shown in FIG. 10, both of the batteries in Examples 4 and 5 have relatively high capacity retentions at different current rates.

Depending on the embodiment, certain of the steps of methods described may be removed, others may be added, and the sequence of steps may be altered. It is also to be understood that the description and the claims drawn to a method may comprise some indication in reference to certain steps. However, the indication used is only to be viewed for identification purposes and not as a suggestion as to an order for the steps.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for making a cathode material of a lithium ion battery comprising:
providing a manganese source liquid solution, a lithium source liquid solution, a phosphate source liquid solution, and a metal M source liquid solution by respectively dissolving a manganese source, a metal M source, a lithium source, and a phosphate source in an organic solvent; and the manganese source and the metal M source are salts of strong acids;
mixing the manganese source liquid solution, the metal M source liquid solution, the lithium source liquid solution, and the phosphate source liquid solution to form a mixing solution; and the mixing solution having a total concentration among the manganese source, the metal M source, the lithium source, and the phosphate source less than or equal to 3 mol/L; and
solvothermal synthesizing the mixing solution to form a product represented by LiMn₍₁₋ₓ₎MₓPO₄, wherein 0<x≦0.1.

2. The method of claim 1, wherein the manganese source is selected from the group consisting of manganese sulfate, manganese nitrate, manganese chloride, and combinations thereof.

3. The method of claim 1, wherein M is selected from the group consisting of Fe, Co, Ni, Mg, Zn, and combinations thereof.

4. The method of claim 1, wherein the lithium source is selected from the group consisting of lithium hydroxide, lithium chloride, lithium sulfate, lithium nitrate, lithium dihydrogen orthophosphate, lithium acetate, and combinations thereof.

5. The method of claim 1, wherein the phosphate source is selected from the group consisting H₃PO₄, LiH₂PO₄, NH₃PO₄, NH₄H₂PO₄, and (NH₄)₂HPO₄.

6. The method of claim 1, wherein the organic solvent is selected from the group consisting of ethylene glycol, glycerol, diethylene glycol, triethylene glycol, tetraethylene glycol, 1,2,4-butanetriol, and combinations thereof.

7. The method of claim 1, wherein the mixing of the Mn source liquid solution, the metal M source liquid solution, the Li source liquid solution, and the phosphate source liquid solution comprises:
previously mixing the phosphate source, the manganese source, and the metal M source liquid solution to form a first solution; and
further mixing the lithium source liquid solution with the first solution to form a second solution.

8. The method of claim 1, wherein the mixing of the Mn source liquid solution, the metal M source liquid solution, the Li source liquid solution, and the phosphate source liquid solution comprises:
previously mixing the lithium source liquid solution and the phosphate source liquid solution to form a third solution; and
further mixing the manganese source and the metal M source liquid solution with the third solution to form a fourth solution.

9. The method of claim 1, wherein the solvothermal synthesizing is at a temperature in a range from about 150° C. to about 250° C.

10. The method of claim 1, wherein the mixing solution further comprises water, and a volume ratio between the water and the organic solvent is smaller than 1:50.

11. The method of claim 1 further comprising coating carbon on the product by mixing the product with a carbon source liquid solution to form a mixture and sintering the mixture.

12. The method of claim 11, wherein the carbon source liquid solution comprises a carbon source compound selected from the group consisting of sucrose, glucose, Span 80, phenolic resins, epoxy resins, furan resins, polyacrylic acid, polyacrylonitrile, polyethylene glycol, polyvinyl alcohol, and combinations thereof.

13. The method of claim 12, wherein a concentration of the carbon source compound in the carbon source liquid solution is in a range from 0.005 g/ml to 0.05 g/ml.

14. The method of claim 1, wherein the product is pure LiMn_{0.9}Fe_{0.1}PO₄.

15. The method of claim 1, wherein the lithium source is LiOH.H₂O, the metal M source is FeSO₄.7H₂O, the manganese source is MnCl₂.4H₂O, the phosphate source is H₃PO₄, and the organic solvent is ethylene glycol; and a concentration of Mn²⁺ is about 0.18 mol/L, a concentration of Fe²⁺ is about 0.02 mol/L, a concentration of Li⁺ is about 0.54 mol/L, and a concentration of PO₄³⁻ is about 0.2 mol/L, a molar ratio among Li⁺, Fe²⁺+Mn²⁺, and PO₄³⁻ is about 2.7:1:1.
